(19) United States
(12) Patent Application Publication
(10) Pub. No.: US 2026/0343249 A1
(43) Pub. Date: Oct. 29, 2026

(54) Optimization of Data Processing Paths in DU and RU using O-RAN FH Extended Bit Assignment for eAxC ID

(71) Applicant: Nokia Solutions and Networks Oy, Espoo (FI)

(72) Inventors: Sebastian Kuczynski, Wroclaw (PL); Pawel Koch, Wroclaw (PL); Lukasz Zdobylak, Wroclaw (PL); Marek Michalak, Malin (PL)

(21) Appl. No.: 19/107,785

(22) PCT Filed: Jul. 11, 2023
(86) PCT No.: PCT/EP2023/069167

§ 371 Date: Feb. 28, 2025

Related U.S. Application Data
(60) Provisional application No. 63/402,557, filed on Aug. 31, 2022.

(51) Int. Cl. H04W 24/02; H04W 24/10

(52) U.S. Cl. CPC H04W 24/02; H04W 24/10

(57) ABSTRACT

In accordance with example embodiments, there is at least a method and apparatus to perform identifying at least one extended Antenna-Carrier identifier (eAxC ID) profile for configuration of at least one of cells or carriers by an operator of a communication network; receiving or using over an Open Radio Access Network (O-RAN) management plane (M-Plane) flow from an Open Radio Access Network radio unit (O-RU) a capability report including a list of at least one eAxC ID subfield assignment supported by the O-RU; mapping the supported at least one eAxC ID subfield assignment to the at least one eAxC ID profile; selecting an optimal and mutually supported eAxC ID profile of the at least one eAxC ID profile; and based on the selecting, configuring endpoints with eAxC ID subfield assignment and eAxC ID values for one of transmitting or receiving a signal for data exchange to available resources over control signal and user data exchange planes.

### TECHNICAL FIELD:

The teachings in accordance with the exemplary embodiments of this invention relate generally to optimization of data processing paths in a distributed unit and radio unit and, more specifically, relate to optimization of data processing paths in the distributed unit and radio unit using Open Radio Access Network front haul extended bit assignment for an extended Antenna-Carrier identifier.

### BACKGROUND:

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
C-Plane: control plane interface—part of O-RAN Alliance fronthaul interface used to convey real-time control for O-RU or O-DU operation including commands for transmission of downlink and reception of uplink signal
CU centralized unit
DU: distributed unit
eAxC extended Antenna-Carrier
eAxC_ID extended Antenna-Carrier identifier
eCPRI common public radio interface
eRE: eCPRI Radio Equipment—a node in the eCPRI system network realizing radio functionalities.
eREC: eCPRI Radio Equipment Control—a node in the eCPRI system network controlling eRE(s).
(Low level) endpoints: HW or SW components of O-RU or O-DU that are processing the real-time control and/or IQ samples.
FH front haul
ID identification
M-Plane: management plane interface—part of O-RAN Alliance fronthaul interface used to convey non-real-time control for O-RU operation including (low level) endpoint configuration.
O-DU: O-RAN Distributed Unit: a node hosting RLC/MAC/High-PHY layers of RF processing.
O-RAN Open Radio Access Network
O-RU: O-RAN Radio Unit: a node hosting Low-PHY layer and RF processing.
PC ID
RTC ID Real-Time Control Data identity
RU radio unit
U-Plane: user plane interface—part of O-RAN Alliance fronthaul interface used to convey IQ sample data between O-DU and O-RU including downlink signal transmitted by O-RU and uplink signal received by O-RU.

O-RAN specification is relying on the eCPRI protocol. eCPRI, which is a way of splitting up the baseband functions and putting some of that functionality in the RRU to reduce the burden on the connection means. U-Plane flow is using eCPRI message type #0 as the transport, while C-Plane flow is using eCPRI message type #2 as the transport. O-RAN C/U-Planes are using PC_ID and RTC_ID to identify U-Plane and C-Plane flows between the O-DU and O-RU. O-RAN further renames the PC_ID and RTC_ID as eAxC ID. It is worth to notice, that C-Plane and U-Plane flows have strong relation between each other, as C-Plane is being used for the control of reception/transmission of the signals that are being conveyed over U-Plane protocol.

O-RAN allows for flexible eAxC ID and subfield assignment on O-RU via O-RAN M-Plane flow. Flexibility in the configuration may disallow to introduce cost optimized O-RUs and O-DUs to the fully standard O-RAN system, especially that O-RU is neither able to share its capabilities effectively nor negotiate with O-DU the commonly supported eAxC ID capabilities. Flexibility in the configuration may also cause suboptimal usage of the O-RU or O-DU processing capabilities that may rely on some of the eAxC ID properties.

To utilize efficiently the capabilities of O-DU and O-RU, vendors of both devices must agree bilaterally outside of O-RAN on the used eAxC ID and subfield assignment during product development phase, as it is not possible to negotiate the capabilities using the current definition of O-RAN standard.

Example embodiments of the invention work to address at least these issues.

### SUMMARY

In an example aspect of the invention, there is an apparatus, such as a network side apparatus, comprising: An Open Radio Access Network distributed unit (O-DU), comprising: at least one processor; and at least one non-transitory memory including computer program code, where the at least one non-transitory memory and the computer program code are configured, with the at least one processor, to cause the Open Radio Access Network distributed unit to at least: identify at least one extended Antenna-Carrier identifier (eAxC ID) profile for configuration of at least one of cells or carriers by an operator of a communication network; receive over an Open Radio Access Network (O-RAN) management plane (M-Plane) flow from an Open Radio Access Network radio unit (O-RU) a capability report comprising a list of at least one extended Antenna-Carrier identifier (eAxC ID) subfield assignment supported by the Open Radio Access Network radio unit (O-RU); map the supported at least one extended Antenna-Carrier identifier (eAxC ID) subfield assignment to the at least one extended Antenna-Carrier identifier (eAxC ID) profile; select an optimal and mutually supported extended Antenna-Carrier identifier (eAxC ID) profile of the at least one extended Antenna-Carrier identifier (eAxC ID) profile; and based on the selecting, configure endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In another example aspect of the invention, there is a method comprising: identifying by an Open Radio Access Network distributed unit (O-DU) at least one extended Antenna-Carrier identifier (eAxC ID) profile for configuration of at least one of cells or carriers by an operator of a communication network; receiving over an Open Radio Access Network (O-RAN) management plane (M-Plane) flow from an Open Radio Access Network radio unit (O-RU) a capability report comprising a list of at least one extended Antenna-Carrier identifier (eAxC ID) subfield assignment supported by the Open Radio Access Network radio unit (O-RU); mapping the supported at least one extended Antenna-Carrier identifier (eAxC ID) subfield assignment to the at least one extended Antenna-Carrier identifier (eAxC ID) profile; selecting an optimal and mutually supported extended Antenna-Carrier identifier (eAxC ID) profile of the at least one extended Antenna-Carrier identifier (eAxC ID) profile; and based on the selecting, configuring endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

A further example embodiment is an apparatus and a method comprising the apparatus and the method of the previous paragraphs, wherein configuring the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations, wherein the at least one of the Open Radio Access Network radio unit (O-RU) or Open Radio Access Network distributed unit (O-DU) processing operations are based on the O-RU or O-DU implementation being optimized for support of only selected eAxC ID subfield assignments or eAxC ID values, wherein configuring the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations, wherein the capability report is identifying supported assignment schemes of more than one subfield using the at least one of the Open Radio Access Network radio unit (O-RU) or Open Radio Access Network distributed unit (O-DU) processing operations, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU), wherein the at least one extended Antenna-Carrier identifier (eAxC ID) profile comprises extended Antenna-Carrier identifier (eAxC ID) assignments to leverage O-RU or O-DU processing, wherein the supported Antenna-Carrier identifier (eAxC ID) profile are implemented on the O-DU and the O-RU, wherein each of the at least one Antenna-Carrier identifier (eAxC ID) profile is uniquely identified by the Antenna-Carrier identifier (eAxC ID) subfield assignment, wherein the O-RU reports over O-RAN M-Plane the supported Antenna-Carrier identifier (eAxC ID) subfield assignments to inform the communication network about the supported eAxC profile, wherein each of the eAxC ID profiles is uniquely identified by the eAxC ID subfield assignment, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures, wherein after at least one of cell or carrier configuration, the O-DU activates cells or carriers and C/U-Plane data is exchanged and processed according to the O-RAN standard procedures, wherein the O-DU retrieves the list of the supported eAxC ID subfield assignments as described in the section, wherein the O-DU maps the eAxC ID subfield assignments supported by O-RU to the eAxC ID profiles, and wherein based on the at least one of cell or carrier configuration provided by the operator of the communication network, O-DU selects the optimal eAxC ID profile that is supported by both the O-RU and the O-DU, wherein the list comprises a list of tuples comprising a DU_Port_ID, BandSector_ID, CC_ID and RU_Port_ID, and/or wherein examples of eAxC characteristics that can be used for selecting the optimal and mutually supported eAxC ID profile comprise at least one of: polarization of the signal that is one of transmitted or received in the eAxC, band of the one of transmitting or receiving the signal of the eAxC, frequency range of the one of transmitted or received signal of the eAxC, or physical sector of the one of transmitted or received signal of the eAxC, and wherein selecting the optimal and mutually supported eAxC ID profile comprises at least one of: usage of eAxC for physical random access channel (PRACH) reception, usage of eAxC for synchronization block (SSB) transmission, usage of eAxC for sounding reference signal (SRS) reception, antenna panel used for one of transmission or reception of the signal that is one of transmitted or received in the eAxC, antenna element used for reception or transmission of the signal that is one of transmitted or received in the eAxC, an LTE, IoT, 5G, or 6G technology of the signal one of transmitted or received in the eAxC, one of a time division (TDD) or frequency division (FDD) duplex type of the signal one of transmitted or received in the eAxC, optical port used for one of transmission or reception of the signal that is one of transmitted or received in the eAxC, or type of beamforming used for the signal that is one of transmitted or received in the eAxC.

A non-transitory computer-readable medium storing program code, the program code executed by at least one processor to perform at least the method as described in the paragraphs above.

In another example aspect of the invention, there is an apparatus comprising: means for identifying by an Open Radio Access Network distributed unit (O-DU) at least one extended Antenna-Carrier identifier (eAxC ID) profile for configuration of at least one of cells or carriers by an operator of a communication network; means for receiving over an Open Radio Access Network (O-RAN) management plane (M-Plane) flow from an Open Radio Access Network radio unit (O-RU) a capability report comprising a list of at least one extended Antenna-Carrier identifier (eAxC ID) subfield assignment supported by the Open Radio Access Network radio unit (O-RU); means for mapping the supported at least one extended Antenna-Carrier identifier (eAxC ID) subfield assignment to the at least one extended Antenna-Carrier identifier (eAxC ID) profile; means for selecting an optimal and mutually supported extended Antenna-Carrier identifier (eAxC ID) profile of the at least one extended Antenna-Carrier identifier (eAxC ID) profile; and means. based on the selecting, for configuring endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In accordance with the example embodiments as described in the paragraph above, at least the means for identifying, receiving, mapping, selecting, and configuring comprises a network interface, and computer program code stored on a computer-readable medium and executed by at least one processor.

In an example aspect of the invention, there is an apparatus, such as a user equipment side apparatus, such as an Open Radio Access Radio unit (O-RU), comprising: at least one processor; and at least one non-transitory memory including computer program code, where the at least one non-transitory memory and the computer program code are configured, with the at least one processor, to cause the Open Radio Access Network Radio unit to at least: identify at least one extended Antenna-Carrier identifier (eAxC ID) profile for configuration of at least one of cells or carriers by an operator of a communication network; use an interface to send to an Open Radio Access Network distributed unit (O-DU) over an Open Radio Access Network (O-RAN) management plane (M-Plane) flow a capability report comprising a list of at least one extended Antenna-Carrier identifier (eAxC ID) subfield assignment supported by the Open Radio Access Network radio unit (O-RU), wherein based on the sending there is: mapping of the supported at least one extended Antenna-Carrier identifier (eAxC ID) subfield assignment to the at least one extended Antenna-Carrier identifier (eAxC ID) profile; selection of an optimal and mutually supported extended Antenna-Carrier identifier (eAxC ID) profile of the at least one extended Antenna-Carrier identifier (eAxC ID) profile; and based on the selection, configuration of endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In another example aspect of the invention, there is a method comprising: identifying by an Open Radio Access Radio unit (O-RU)at least one extended Antenna-Carrier identifier (eAxC ID) profile for configuration of at least one of cells or carriers by an operator of a communication network; using an interface to send to an Open Radio Access Network distributed unit (O-DU) over an Open Radio Access Network (O-RAN) management plane (M-Plane) flow a capability report comprising a list of at least one extended Antenna-Carrier identifier (eAxC ID) subfield assignment supported by the Open Radio Access Network radio unit (O-RU), wherein based on the sending there is: mapping of the supported at least one extended Antenna-Carrier identifier (eAxC ID) subfield assignment to the at least one extended Antenna-Carrier identifier (eAxC ID) profile; selection of an optimal and mutually supported extended Antenna-Carrier identifier (eAxC ID) profile of the at least one extended Antenna-Carrier identifier (eAxC ID) profile; and based on the selection, configuration of endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

A further example embodiment is an apparatus and a method comprising the apparatus and the method of the previous paragraphs, wherein the configuration of the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations, wherein the at least one of the Open Radio Access Network radio unit (O-RU) or Open Radio Access Network distributed unit (O-DU) processing operations is based on the O-RU or O-DU implementation being optimized for support of only selected eAxC ID subfield assignments or eAxC ID values, wherein configuration of the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations, wherein the interface to send the list of the supported at least one extended Antenna-Carrier identifier (eAxC ID) subfield assignment comprises a a list of tuples comprising a DU_Port_ID, BandSector_ID, CC_ID and RU_Port_ID, wherein the capability report is identifying supported assignment schemes of more than one subfield using the at least one of the Open Radio Access Network radio unit (O-RU) or Open Radio Access Network distributed unit (O-DU) processing operations, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU), wherein the at least one extended Antenna-Carrier identifier (eAxC ID) profile comprises extended Antenna-Carrier identifier (eAxC ID) assignments to leverage O-RU or O-DU processing, wherein the supported Antenna-Carrier identifier (eAxC ID) profile are implemented on the O-DU and the O-RU, wherein each of the at least one Antenna-Carrier identifier (eAxC ID) profile is uniquely identified by the Antenna-Carrier identifier (eAxC ID) subfield assignment, wherein the O-RU reports over O-RAN M-Plane the supported Antenna-Carrier identifier (eAxC ID) subfield assignments to inform the communication network about the supported eAxC profile, wherein each of the eAxC ID profiles is uniquely identified by the eAxC ID subfield assignment, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures, wherein after at least one of cell or carrier configuration, the O-DU activates cells or carriers and C/U-Plane data is exchanged and processed according to the O-RAN standard procedures, wherein the O-DU retrieves the list of the supported eAxC ID subfield assignments, wherein the O-DU maps the eAxC ID subfield assignments supported by O-RU to the eAxC ID profiles as described in the section, and wherein based on the at least one of cell or carrier configuration provided by the operator of the communication network, O-DU selects the optimal eAxC ID profile that is supported by both the O-RU and the O-DU, wherein examples of eAxC characteristics that can be used for selecting the optimal and mutually supported eAxC ID profile comprise at least one of: polarization of the one of transmitted or received signal of the eAxC, band of the one of transmitted or received signal of the eAxC, frequency range of the one of transmitted or received signal of the eAxC, or physical sector of the transmitted/received signal that is one of transmitted or received in the eAxC, wherein selecting the optimal and mutually supported eAxC ID profile comprise at least one of: usage of eAxC for physical random access channel (PRACH) reception, usage of eAxC for synchronization block (SSB) transmission, usage of eAxC for sounding reference signal (SRS) reception, antenna panel used for one of transmission or reception of the signal that is one of transmitted or received in the eAxC, antenna element used for reception or transmission of the signal that is one of transmitted or received in the eAxC, an LTE, IoT, 5G, or 6G technology of the signal one of transmitted or received in the eAxC, one of a time division (TDD) or frequency division (FDD) duplex type of the signal one of transmitted or received in the eAxC, optical port used for one of transmission or reception of the signal that is one of transmitted or received in the eAxC, or type of beamforming used for the signal that is one of transmitted or received in the eAxC.

A non-transitory computer-readable medium storing program code, the program code executed by at least one processor to perform at least the method as described in the paragraphs above.

In another example aspect of the invention, there is an apparatus comprising: means for identifying by an Open Radio Access Radio unit (O-RU)at least one extended Antenna-Carrier identifier (eAxC ID) profile for configuration of at least one of cells or carriers by an operator of a communication network; means for using an interface to send to an Open Radio Access Network distributed unit (O-DU) over an Open Radio Access Network (O-RAN) management plane (M-Plane) flow a capability report comprising a list of at least one extended Antenna-Carrier identifier (eAxC ID) subfield assignment supported by the Open Radio Access Network radio unit (O-RU), wherein based on the sending there is: means for mapping of the supported at least one extended Antenna-Carrier identifier (eAxC ID) subfield assignment to the at least one extended Antenna-Carrier identifier (eAxC ID) profile; means for selection of an optimal and mutually supported extended Antenna-Carrier identifier (eAxC ID) profile of the at least one extended Antenna-Carrier identifier (eAxC ID) profile; and means, based on the selection, for configuration of endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In accordance with the example embodiments as described in the paragraph above, at least the means for identifying, using, sending, mapping, selecting, and configuring comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a conceptual processing of the eAxC in O-RU and O-DU;

FIG. 2 shows a table 2 showing an eAxC ID definition and exemplary subfield assignment;

FIG. 3 shows a table 1 showing an example of an eAxC ID profile;

FIG. 4 shows mapping between the eAxC ID subfields and eAxC ID profiles in accordance with example embodiments of the invention;

FIG. 5 shows table 3 showing an interface to report supported eAxC ID subfields assignments in accordance with example embodiments of the invention;

FIG. 6 shows steps of negotiation of the optimal mutually supported eAxC ID profile in accordance with example embodiments of the invention;

FIG. 7 shows a high level block diagram of various devices used in carrying out various aspects of the invention;

FIG. 8A and FIG. 8B each show a method in accordance with example embodiments of the invention which may be performed by an apparatus.

### DETAILED DESCRIPTION:

In example embodiments of this invention there is proposed at least a method and apparatus to perform optimization of data processing paths in the distributed unit and radio unit using Open Radio Access Network front haul extended bit assignment for an extended Antenna-Carrier identifier.

In eCPRI systems, the communication is happening over a packet based fronthaul transport. On top of the packet based fronthaul transport, eCPRI specifies the messages that are being used for exchange the data between eREC (e.g., O-DU) and eRE (e.g., O-RU). Some of the messages (especially, but not limited to, message type #0 used for IQ data transfer and message type #2 used for real-time control data exchange) defined by the eCPRI standard are using a notion of a 16-bit identifier of the communication flow, namely PC_ID and RTC_ID.

As similarly stated above, O-RAN specification is relying on the eCPRI protocol. U-Plane flow is using eCPRI message type #0 as the transport, while C-Plane flow is using eCPRI message type #2 as the transport. O-RAN C/U-Planes are using PC_ID and RTC_ID to identify U-Plane and C-Plane flows between the O-DU and O-RU. O-RAN further renames the PC ID and RTC_ID as eAxC ID. It is worth to notice, that C-Plane and U-Plane flows have strong relation between each other, as C-Plane is being used for the control of reception/transmission of the signals that are being conveyed over U-Plane protocol.

eAxC IDs are further used by both O-DU and O-RU to identify the flows and apply proper processing of real time control (conveyed over C-Plane) and IQ samples (conveyed over U-Plane). The processing is happening in either HW or SW components of O-DU and O-RU, to which the data is being routed using also eAxC ID identifiers. HW or SW components doing the processing are called (low level) endpoints in O-RAN specification. eAxC is used shortly to describe the flows of C-Plane and U-Plane specific to a single endpoint resource.

Process of allocation of the eAxC IDs to the O-RU's endpoints that are processing the real time control and IQ samples is happening over the O-RAN M-Plane flow. O-RAN M-Plane is the flow used for non-real-time control of the O-RU.

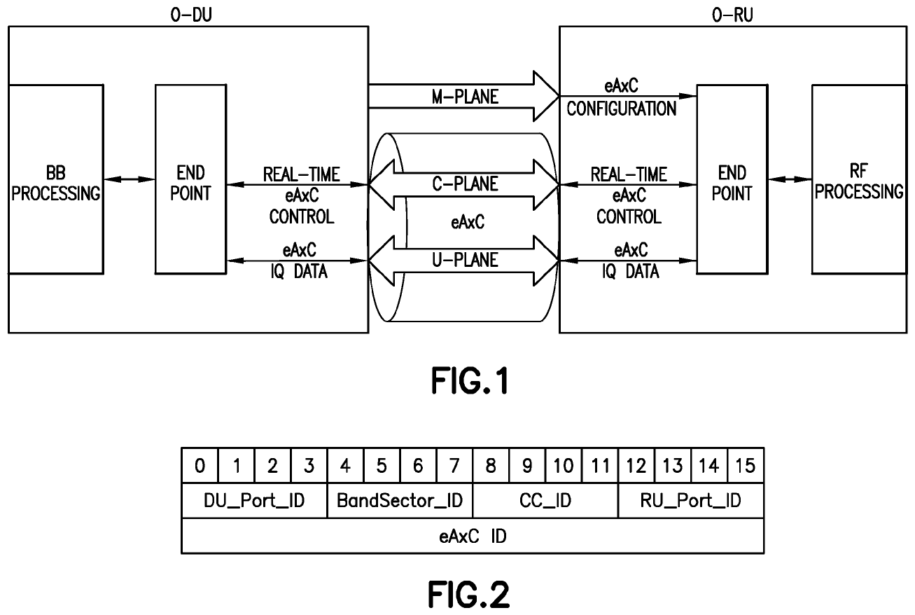

FIG. 1 shows a conceptual processing of the eAxC in O-RU and O-DU. As shown in FIG. 1 there is operations between ab O-DU and an O-RU using an M-Plane and an eAxC with a C-Plane and a U-Plane.

O-RAN standard further subdivides the eAxC ID to 4 subfields: DU_Port_ID, BandSector_ID, CC_ID and RU_Port_ID. Those subfields do not have any strongly defined semantics, which means that usage of those fields can differ significantly between O-DU and O-RU vendors. Therefore neither O-DU nor O-RU can make any kind of processing assumptions basing just on the configured allocation of the subfields or eAxC ID values.

FIG. 2 shows a table 2 showing an eAxC ID definition and exemplary subfield assignment. As shown in FIG. 2 there is a DU-Port_ID, a BandSector_ID, a CC_ID, and an RU Port ID over an eAxC ID.

O-RU and O-DU has strong demand of efficient real-time control and IQ data processing to serve telecommunication use cases. The requirements of efficient data processing can be as stringent as tens of microseconds. Due to efficiency, cost and heat constrains, in many cases, the solutions related to the processing are HW-based.

Cost-optimized and HW-based solutions may bring restrictions to the configurability and especially to the configurability of the eAxC ID e.g., some of the HWs may require that certain processing flows are allocated to the eAxC IDs having certain properties. Those properties may be further used by the O-RU or O-DU design to optimize the eAxC processing e.g., by load balancing of the C/U-Plane flows evenly to the available resources.

As similarly stated above, O-RAN allows for flexible eAxC ID and subfield assignment on O-RU via O-RAN M-Plane flow. Flexibility in the configuration may disallow to introduce cost optimized O-RUs and O-DUs to the fully standard O-RAN system, especially that O-RU is neither able to share its capabilities effectively nor negotiate with O-DU the commonly supported eAxC ID capabilities. Flexibility in the configuration may also cause suboptimal usage of the O-RU or O-DU processing capabilities that may rely on some of the eAxC ID properties.

However, to utilize efficiently the capabilities of O-DU and O-RU, vendors of both devices must agree bilaterally outside of O-RAN on the used eAxC ID and subfield assignment during product development phase. It is not possible to negotiate the capabilities using the current definition of O-RAN standard.

O-RAN Alliance's specifications neither specify interface to report eAxC ID capabilities of O-RU nor specify way of eAxC ID capability negotiation between O-RU and O-DU.

In many cases, it is O-DU and O-RU vendors to agree outside of O-RAN how to effectively utilize eAxC IDs.

It is proposed to introduce a notion of “eAxC ID profile” that describes the eAxC ID processing capabilities of O-RU or O-DU, as well as the optimal way of eAxC ID assignment that allows to fully leverage O-RU or O-DU processing potential. Each profile is identified by the assignment of standard O-RAN subfields i.e., DU_Port_ID, BandSector_ID, CC_ID and RU Port ID.

The eAxC ID profile is based on the characteristics of the processed eAxCs and mapping to the specific eAxC ID subfields or values. The examples of eAxC characteristics are provided in the detailed description of the invention. The mapping to the specific eAxC ID subfield or values can be done by defining eAxC ID bitmasks or providing exact values of eAxC ID bits defined by the bitmasks.

Further, it is proposed to introduce to the O-RAN M-Plane, the capability report sent by O-RU to O-DU that tells which schemes of assignment of standard O-RAN subfields (i.e., DU_Port_ID, BandSector_ID, CC_ID and RU_Port_ID) are supported. Those assignments are identifying uniquely the eAxC ID profiles supported by O-RU. The information about eAxC ID profiles supported by O-RU can be then leveraged to negotiate and select the most suitable eAxC ID profile that is supported by both O-DU and O-RU. O-DU uses the information from the selected eAxC ID profile to configure the eAxC IDs on O-RU in the optimal way.

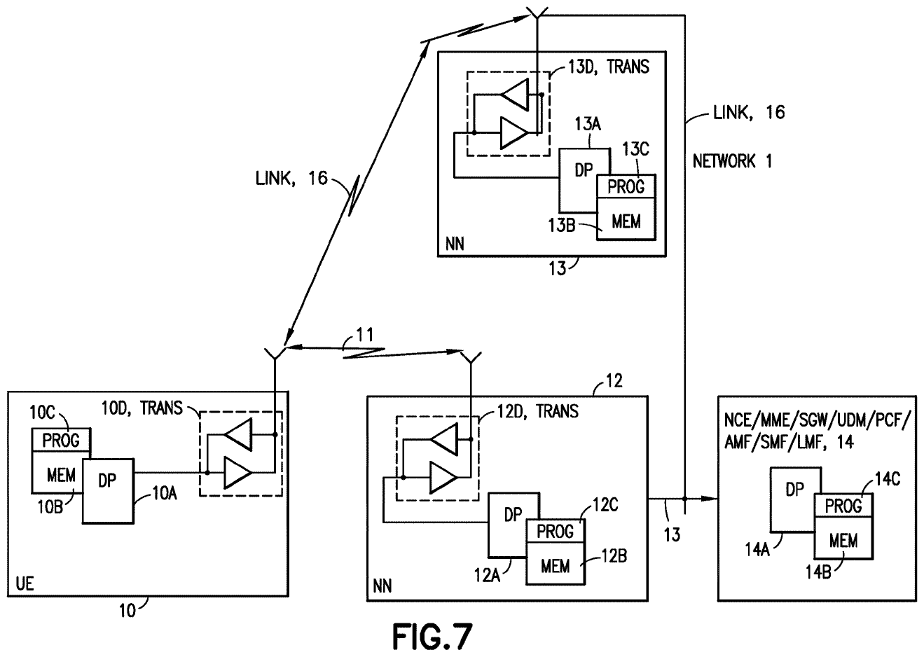

Before describing the example embodiments of the invention in detail, reference is made to FIG. 7 for illustrating a simplified block diagram of various electronic devices that are suitable for use in practicing the example embodiments of this invention.

FIG. 7 shows a block diagram of one possible and non-limiting exemplary system in which the example embodiments of the invention may be practiced. In FIG. 7, a user equipment (UE) 10 is in wireless communication with a wireless network 1 or network, 1 as in FIG. 7. The wireless network 1 or network 1 as in FIG. 7 can comprise a communication network such as a mobile network e.g., the mobile network 1 or first mobile network as disclosed herein. Any reference herein to a wireless network 1 as in FIG. 7 can be seen as a reference to any wireless network as disclosed herein. Further, the wireless network 1 as in FIG. 7 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 7. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 7. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 7 can be used for communication between the NN12 and the NN13. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 7.

The one or more buses of the device of FIG. 7 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 7 shows a network nodes such as NN 12 and NN 13, any of these nodes may can incorporate or be incorporated into an eNodeB or eNB or gNB such as for LTE and NR, and would still be configurable to perform example embodiments of the invention.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the invention.

It is noted that that the NN 12 and/or NN 13 and/or UE 10 can be configured (e.g. based on standards implementations etc.) to perform functionality of a Location Management Function (LMF). The LMF functionality may be embodied in either of the Content Consumer A, Content Consumer B, Dash Server, and/or Content Provider or may be part of these network devices or other devices associated with these devices. In addition, an LMF such as the LMF of the MME/SGW/UDM/PCF/AMF/SMF/LMF 14 of FIG. 7, as at least described below, can be co-located with UE 10 such as to be separate from the NN 12 and/or NN 13 of FIG. 7 for performing operations in accordance with example embodiments of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

### eAxC ID profile

eAxC ID profile describes the eAxC ID processing capabilities of any of the O-RU and/or O-DU, as well as the optimal way of eAxC ID assignment that allows to fully leverage O-RU or O-DU processing potential. The eAxC ID profile is based on the characteristics of the processed eAxCs and mapping to the specific eAxC ID subfields or values.
The examples of eAxC characteristics that can be used for definition of the profile include:
Polarization of the transmitted/received signal that is conveyed in eAxC,
Band of the transmitted/received signal that is conveyed in eAxC,
Frequency range of the transmitted/received signal that is conveyed in eAxC,
Physical sector of the transmitted/received signal that is conveyed in eAxC,
Usage of eAxC for PRACH reception,
Usage of eAxC for SSB transmission,
Usage of eAxC for SRS reception,
Antenna panel used for transmission/reception of the signal that is conveyed in eAxC,
Antenna element used for reception/transmission of the signal that is conveyed in eAxC,
Technology (e.g., LTE, IT, 5G, 6G) of the signal conveyed in eAxC,
Duplex type (TDD or FDD) of the signal conveyed in eAxC,
Optical port used for transmission/reception of the signal that is conveyed in eAxC, and/or
Type of beamforming used for the transmitted/received signal that is conveyed in eAxC.

O-RU and O-DU may use one, many or any combination of eAxC characteristics to define the profile according to the design decisions.

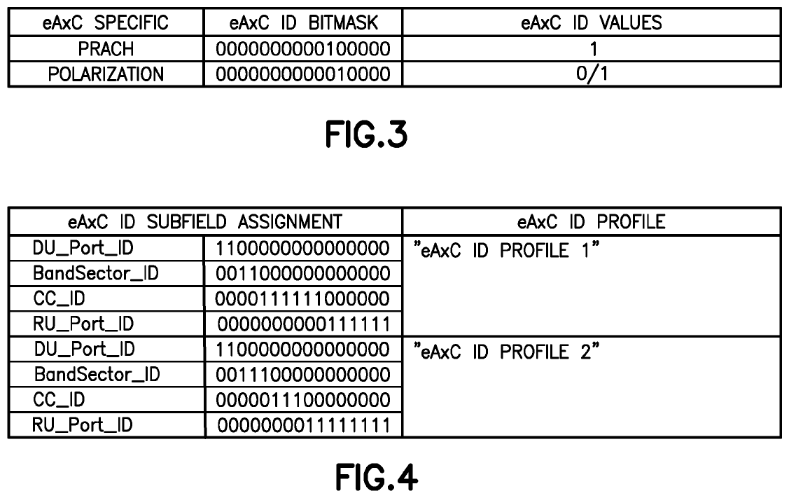

FIG. 3 shows a table 1 showing an example of an eAxC ID profile. As shown in FIG. 3 there are eAxC ID bitmask and eAxC ID values for eAxC specific PRACH and Polarization.

The mapping to the specific eAxC ID subfield or values can be done by defining eAxC ID bitmasks and/or providing exact values of eAxC ID bits defined by the bitmasks. As an example profile defining that PRACH differentiating bit shall be placed on the 10^{th} position with the value of 1 and polarization differentiating bit shall be placed on the 11^{th} position may look as shown in FIG. 3.

It is worth to note that some bitmasks may affect more than one bit e.g., a bitmask defining technology may require two bits if more than 2 technologies are supported by O-DU or O-RU.

FIG. 4 shows mapping between the eAxC ID subfields and eAxC ID profiles in accordance with example embodiments of the invention.

Each eAxC ID profile is uniquely identified by the relation to the O-RAN defined eAxC ID subfields i.e., DU_Port_ID, BandSector_ID, CC_ID and RU_Port_ID. Assignment of eAxC ID subfields is realized using bitmasks as defined in O-RAN. Number of profiles supported by O-RU and O-DU depends on the design decisions. An exemplary mapping between the eAxC ID subfields and eAxC ID profile may look as shown in FIG. 4.

It is worth to note that encoding of eAxC ID subfields assignment can be done also in other, possibly more optimal ways e.g., by providing the number of bits assigned to each subfield like 2-2-6-6 that could be used to define the eAxC ID subfield assignment for “eAxC ID Profile 1” in Error! Reference source not found.

### O-RU Report of the Set of Supported eAxC ID Subfield Assignments

As each of the eAxC ID profiles is uniquely identified by the eAxC ID subfield assignment, O-RU shall report over O-RAN M-Plane the supported eAxC ID subfield assignments to implicitly inform about the supported eAxC profiles. Number of eAxC ID subfield assignments supported by O-RU depends on the design decisions.

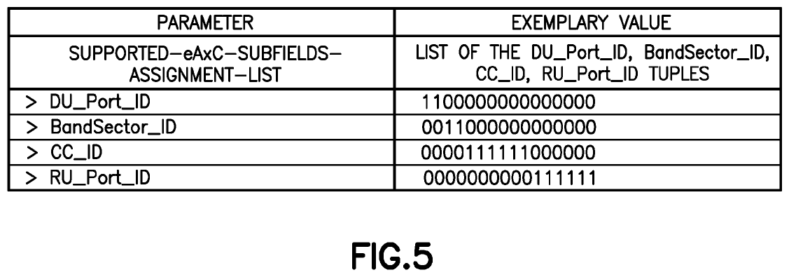

FIG. 5 shows table 3 showing an interface to report supported eAxC ID subfields assignments in accordance with example embodiments of the invention;

It is worth to note that encoding of eAxC ID subfields assignment can be done also in other, possibly more optimal ways e.g., by providing the number of bits assigned to each subfield like 2-2-6-6 that could be used to define the eAxC ID subfield assignment for the example in Error! Reference source not found. of FIG. 5.

### Negotiation of the Optimal Mutually Supported eAxC ID Profiles

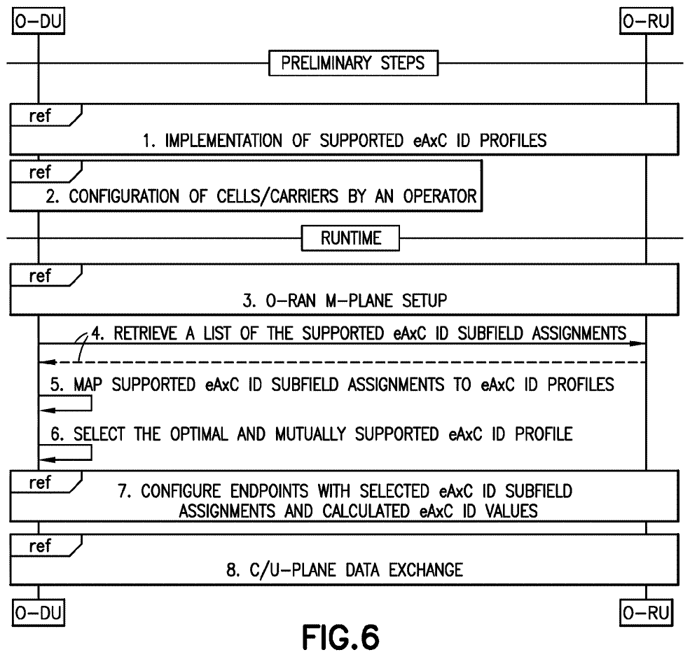

FIG. 6 shows steps of negotiation of the optimal mutually supported eAxC ID profile in accordance with example embodiments of the invention.

Negotiation of the mutually supported eAxC ID profile shall happen basing on the means of the O-RAN M-Plane and a database of the eAxC ID profiles in O-DU. As the result, the process of negotiation shall yield the optimal and mutually supported eAxC ID profile. The process can be described by the following list of steps as shown in FIG. 6:
1. Implementation of supported eAxC ID profiles:
   Supported eAxC ID profiles are implemented on an O-DU and an O-RU;
2. Configuration of cells/carriers by an operator:
   An operator configures cells/carriers directly or indirectly with management interface of the O-DU;
3. O-RAN M-Plane setup:
   O-RAN M-Plane connection established between the O-DU and the O-RU according to the standard procedure;
4. Retrieve a list of the supported eAxC ID subfield assignments:
   O-DU retrieves the list of the supported eAxC ID subfield assignments as described in the section ;
5. Map supported eAxC ID subfield assignments to eAxC ID profiles:
   O-DU maps the eAxC ID subfield assignments supported by O-RU to the eAxC ID profiles as described in the section
   Before describing the example embodiments of the invention in detail, reference is made to FIG. 7 for illustrating a simplified block diagram of various electronic devices that are suitable for use in practicing the example embodiments of this invention.

FIG. 7 shows a block diagram of one possible and non-limiting exemplary system in which the example embodiments of the invention may be practiced. In FIG. 7, a user equipment (UE) 10 is in wireless communication with a wireless network 1 or network, 1 as in FIG. 7. The wireless network 1 or network 1 as in FIG. 7 can comprise a communication network such as a mobile network e.g., the mobile network 1 or first mobile network as disclosed herein. Any reference herein to a wireless network 1 as in FIG. 7 can be seen as a reference to any wireless network as disclosed herein. Further, the wireless network 1 as in FIG. 7 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 7. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 7. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 7 can be used for communication between the NN12 and the NN13. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 7.

The one or more buses of the device of FIG. 7 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 7 shows a network nodes such as NN 12 and NN 13, any of these nodes may can incorporate or be incorporated into an eNodeB or eNB or gNB such as for LTE and NR, and would still be configurable to perform example embodiments of the invention.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the invention.

It is noted that that the NN 12 and/or NN 13 and/or UE 10 can be configured (e.g. based on standards implementations etc.) to perform functionality of a Location Management Function (LMF). The LMF functionality may be embodied in either of the Content Consumer A, Content Consumer B, Dash Server, and/or Content Provider or may be part of these network devices or other devices associated with these devices. In addition, an LMF such as the LMF of the MME/SGW/UDM/PCF/AMF/SMF/LMF 14 of FIG. 7, as at least described below, can be co-located with UE 10 such as to be separate from the NN 12 and/or NN 13 of FIG. 7 for performing operations in accordance with example embodiments of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

### eAxC ID Profile

6. Select the optimal and mutually supported eAxC ID profile:
   Based on the cell/carrier configuration provided by the operator, O-DU selects the optimal eAxC ID profile that is both supported by O-RU and the O-DU;
7. Configure endpoints with selected eAxC ID subfield assignments and calculated eAxC ID values:
   As a part of cell/carrier configuration on the O-RU, the O-DU configures the endpoints on both O-DU and O-RU side with the selected eAxC ID subfield assignments and calculated eAxC ID values basing on the selected profile according to the standard procedures; and
8. C/U-Plane data exchange:
   After cell/carrier configuration, the O-DU activates the cells/carriers and C/U-Plane data is exchanged and processed according to the O-RAN standard procedures. The O-DU and the O-RU takes advantage of the selected optimal profile, to effectively utilize the resources.

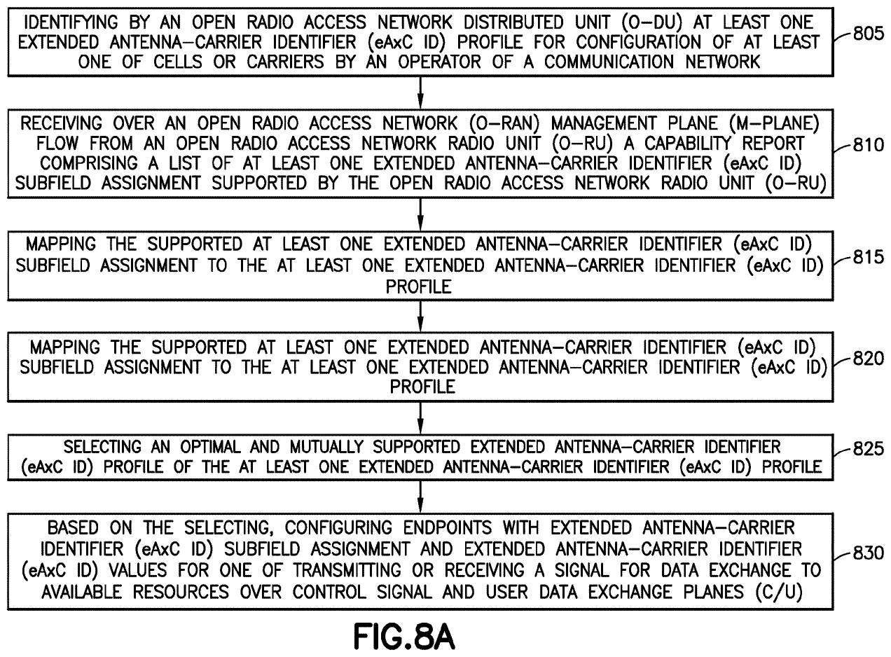

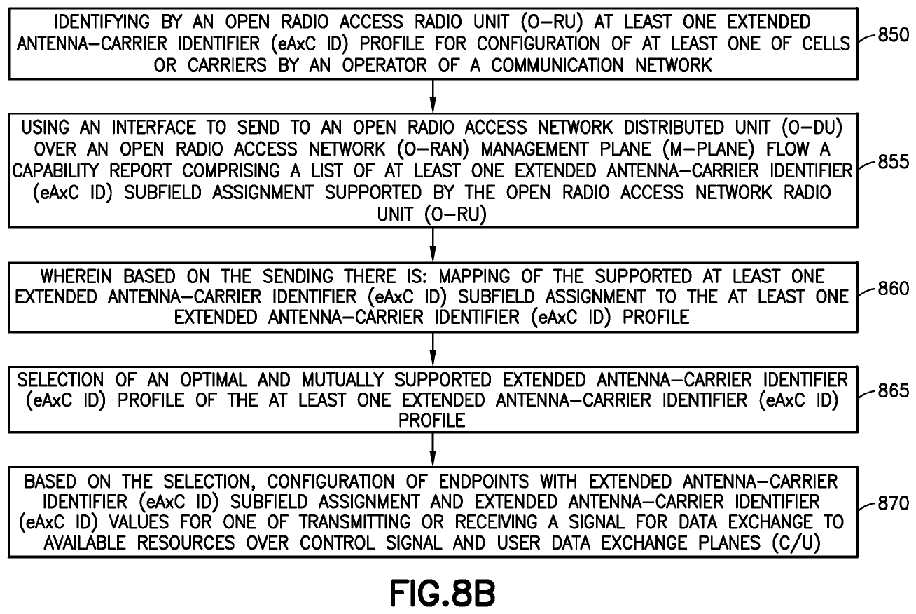

FIG. 8A and FIG. 8B each show a method in accordance with example embodiments of the invention which may be performed by an apparatus.

FIG. 8A illustrates operations which may be performed by a network device such as, but not limited to, a network node NN 12 and/or NN 13 as in FIG. 7. As shown in step 705 of FIG. 7A there is identifying by an Open Radio Access Network distributed unit (O-DU) at least one extended Antenna-Carrier identifier (eAxC ID) profile for configuration of at least one of cells or carriers by an operator of a communication network. As shown in step 710 of FIG. 7A there is receiving over an Open Radio Access Network (O-RAN) management plane (M-Plane) flow from an Open Radio Access Network radio unit (O-RU) a capability report comprising a list of at least one extended Antenna-Carrier identifier (eAxC ID) subfield assignment supported by the Open Radio Access Network radio unit (O-RU). As shown in step 715 of FIG. 7A there is mapping the supported at least one extended Antenna-Carrier identifier (eAxC ID) subfield assignment to the at least one extended Antenna-Carrier identifier (eAxC ID) profile. As shown in step 720 of FIG. 7A there is selecting an optimal and mutually supported extended Antenna-Carrier identifier (eAxC ID) profile of the at least one extended Antenna-Carrier identifier (eAxC ID) profile. Then as shown in step 725 of FIG. 7A there is, based on the selecting, configuring endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In accordance with the example embodiments as described in the paragraph above, wherein configuring the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations.

In accordance with the example embodiments as described in the paragraphs above, wherein the at least one of the Open Radio Access Network radio unit (O-RU) or Open Radio Access Network distributed unit (O-DU) processing operations are based on the O-RU or O-DU implementation being optimized for support of only selected eAxC ID subfield assignments or eAxC ID values.

In accordance with the example embodiments as described in the paragraphs above, wherein configuring the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations.

In accordance with the example embodiments as described in the paragraphs above, wherein the capability report is identifying supported assignment schemes of more than one subfield using the at least one of the Open Radio Access Network radio unit (O-RU) or Open Radio Access Network distributed unit (O-DU) processing operations.

In accordance with the example embodiments as described in the paragraphs above, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU).

In accordance with the example embodiments as described in the paragraphs above, wherein the at least one extended Antenna-Carrier identifier (eAxC ID) profile comprises extended Antenna-Carrier identifier (eAxC ID) assignments to leverage O-RU or O-DU processing.

In accordance with the example embodiments as described in the paragraphs above, wherein the supported Antenna-Carrier identifier (eAxC ID) profile are implemented on the O-DU and the O-RU.

In accordance with the example embodiments as described in the paragraphs above, wherein each of the at least one Antenna-Carrier identifier (eAxC ID) profile is uniquely identified by the Antenna-Carrier identifier (eAxC ID) subfield assignment.

In accordance with the example embodiments as described in the paragraphs above, wherein the O-RU reports over O-RAN M-Plane the supported Antenna-Carrier identifier (eAxC ID) subfield assignments to inform the communication network about the supported eAxC profile.

In accordance with the example embodiments as described in the paragraphs above, wherein each of the eAxC ID profiles is uniquely identified by the eAxC ID subfield assignment.

In accordance with the example embodiments as described in the paragraphs above, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures.

In accordance with the example embodiments as described in the paragraphs above, wherein after at least one of cell or carrier configuration, the O-DU activates cells or carriers and C/U-Plane data is exchanged and processed according to the O-RAN standard procedures.

In accordance with the example embodiments as described in the paragraphs above, wherein the O-DU retrieves the list of the supported eAxC ID subfield assignments as described in the section, wherein the O-DU maps the eAxC ID subfield assignments supported by O-RU to the eAxC ID profiles, and wherein based on the at least one of cell or carrier configuration provided by the operator of the communication network, O-DU selects the optimal eAxC ID profile that is supported by both the O-RU and the O-DU.

In accordance with the example embodiments as described in the paragraphs above, wherein the list comprises a list of tuples comprising a DU_Port_ID, BandSector_ID, CC_ID and RU_Port_ID.

In accordance with the example embodiments as described in the paragraphs above, wherein examples of eAxC characteristics that can be used for selecting the optimal and mutually supported eAxC ID profile comprise at least one of: polarization of the signal that is one of transmitted or received in the eAxC, band of the one of transmitting or receiving the signal of the eAxC, frequency range of the one of transmitted or received signal of the eAxC, or physical sector of the one of transmitted or received signal of the eAxC, and wherein selecting the optimal and mutually supported eAxC ID profile comprises at least one of: usage of eAxC for physical random access channel (PRACH) reception, usage of eAxC for synchronization block (SSB) transmission, usage of eAxC for sounding reference signal (SRS) reception, antenna panel used for one of transmission or reception of the signal that is one of transmitted or received in the eAxC, antenna element used for reception or transmission of the signal that is one of transmitted or received in the eAxC, an LTE, IoT, 5G, or 6G technology of the signal one of transmitted or received in the eAxC, one of a time division (TDD) or frequency division (FDD) duplex type of the signal one of transmitted or received in the eAxC, optical port used for one of transmission or reception of the signal that is one of transmitted or received in the eAxC, or type of beamforming used for the signal that is one of transmitted or received in the eAxC.

A non-transitory computer-readable medium (MEM 12B and/or MEM 13B as in FIG. 7) storing program code (PROG 12C and/or PROG 13C as in FIG. 7), the program code executed by at least one processor (DP 12A and/or DP 13A as in FIG. 7) to perform the operations as at least described in the paragraphs above.

In accordance with an example embodiment of the invention as described above there is an apparatus comprising: means for identify (one or more transceivers 12D and/or 13D; MEM 12B and/or MEM 13B; PROG 12C and/or PROG 13C; and DP 12A and/or DP 13A as in FIG. 7) by an Open Radio Access Network distributed unit (O-DU) (NN 12 and/or NN 13 as in FIG. 7) at least one extended Antenna-Carrier identifier (eAxC ID) profile for configuration of at least one of cells or carriers by an operator of a communication network (Network 1 as in FIG. 7); means for receiving ( ) over an Open Radio Access Network (O-RAN) management plane (M-Plane) flow from an Open Radio Access Network radio unit (O-RU) a capability report comprising a list of at least one extended Antenna-Carrier identifier (eAxC ID) subfield assignment supported by the Open Radio Access Network radio unit (O-RU); means for mapping (one or more transceivers 12D and/or 13D; MEM 12B and/or MEM 13B; PROG 12C and/or PROG 13C; and DP 12A and/or DP 13A as in FIG. 7) the supported at least one extended Antenna-Carrier identifier (eAxC ID) subfield assignment to the at least one extended Antenna-Carrier identifier (eAxC ID) profile; means for selecting (one or more transceivers 12D and/or 13D; MEM 12B and/or MEM 13B; PROG 12C and/or PROG 13C; and DP 12A and/or DP 13A as in FIG. 7) an optimal and mutually supported extended Antenna-Carrier identifier (eAxC ID) profile of the at least one extended Antenna-Carrier identifier (eAxC ID) profile; and means, based on the selecting, for configuring (one or more transceivers 12D and/or 13D; MEM 12B and/or MEM 13B; PROG 12C and/or PROG 13C; and DP 12A and/or DP 13A as in FIG. 7) endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In the example aspect of the invention according to the paragraph above, wherein at least the means for identifying, receiving, mapping, selecting, and configuring comprises a non-transitory computer readable medium [MEM 12B and/or MEM 13B as in FIG. 7] encoded with a computer program [PROG 12C and/or PROG 13C as in FIG. 7] executable by at least one processor [DP 12A and/or DP 13A as in FIG. 7].

FIG. 8B illustrates operations which may be performed by a device such as, but not limited to, a device (e.g., the UE 10 as in FIG. 7). As shown in step 850 of FIG. 8B there is identifying by an Open Radio Access Radio unit (O-RU)at least one extended Antenna-Carrier identifier (eAxC ID) profile for configuration of at least one of cells or carriers by an operator of a communication network. As shown in step 855 of FIG. 8B there is using an interface to send to an Open Radio Access Network distributed unit (O-DU) over an Open Radio Access Network (O-RAN) management plane (M-Plane) flow a capability report comprising a list of at least one extended Antenna-Carrier identifier (eAxC ID) subfield assignment supported by the Open Radio Access Network radio unit (O-RU). As shown in step 860 of FIG. 8B wherein based on the sending there is mapping of the supported at least one extended Antenna-Carrier identifier (eAxC ID) subfield assignment to the at least one extended Antenna-Carrier identifier (eAxC ID) profile. In step 865 of FIG. 8B there is selection of an optimal and mutually supported extended Antenna-Carrier identifier (eAxC ID) profile of the at least one extended Antenna-Carrier identifier (eAxC ID) profile. Then as shown in step 870 of FIG. 8B there is, based on the selection, configuration of endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In accordance with the example embodiments as described in the paragraph above, wherein the configuration of the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations.

In accordance with the example embodiments as described in the paragraphs above, wherein the at least one of the Open Radio Access Network radio unit (O-RU) or Open Radio Access Network distributed unit (O-DU) processing operations is based on the O-RU or O-DU implementation being optimized for support of only selected eAxC ID subfield assignments or eAxC ID values.

In accordance with the example embodiments as described in the paragraphs above, wherein configuration of the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations.

In accordance with the example embodiments as described in the paragraphs above, wherein the interface to send the list of the supported at least one extended Antenna-Carrier identifier (eAxC ID) subfield assignment comprises a a list of tuples comprising a DU_Port_ID, BandSector_ID, CC_ID and RU_Port_ID.

In accordance with the example embodiments as described in the paragraphs above, wherein the capability report is identifying supported assignment schemes of more than one subfield using the at least one of the Open Radio Access Network radio unit (O-RU) or Open Radio Access Network distributed unit (O-DU) processing operations.

In accordance with the example embodiments as described in the paragraphs above, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU).

In accordance with the example embodiments as described in the paragraphs above, wherein the at least one extended Antenna-Carrier identifier (eAxC ID) profile comprises extended Antenna-Carrier identifier (eAxC ID) assignments to leverage O-RU or O-DU processing.

In accordance with the example embodiments as described in the paragraphs above, wherein the supported Antenna-Carrier identifier (eAxC ID) profile are implemented on the O-DU and the O-RU.

In accordance with the example embodiments as described in the paragraphs above, wherein each of the at least one Antenna-Carrier identifier (eAxC ID) profile is uniquely identified by the Antenna-Carrier identifier (eAxC ID) subfield assignment.

In accordance with the example embodiments as described in the paragraphs above, wherein the O-RU reports over O-RAN M-Plane the supported Antenna-Carrier identifier (eAxC ID) subfield assignments to inform the communication network about the supported eAxC profile.

In accordance with the example embodiments as described in the paragraphs above, wherein each of the eAxC ID profiles is uniquely identified by the eAxC ID subfield assignment.

In accordance with the example embodiments as described in the paragraphs above, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures.

In accordance with the example embodiments as described in the paragraphs above, wherein after at least one of cell or carrier configuration, the O-DU activates cells or carriers and C/U-Plane data is exchanged and processed according to the O-RAN standard procedures.

In accordance with the example embodiments as described in the paragraphs above, wherein the O-DU retrieves the list of the supported eAxC ID subfield assignments, wherein the O-DU maps the eAxC ID subfield assignments supported by O-RU to the eAxC ID profiles as described in the section, and wherein based on the at least one of cell or carrier configuration provided by the operator of the communication network, O-DU selects the optimal eAxC ID profile that is supported by both the O-RU and the O-DU.

In accordance with the example embodiments as described in the paragraphs above, wherein examples of eAxC characteristics that can be used for selecting the optimal and mutually supported eAxC ID profile comprise at least one of: polarization of the one of transmitted or received signal of the eAxC, band of the one of transmitted or received signal of the eAxC, frequency range of the one of transmitted or received signal of the eAxC, or physical sector of the transmitted/received signal that is one of transmitted or received in the eAxC, wherein selecting the optimal and mutually supported eAxC ID profile comprise at least one of: usage of eAxC for physical random access channel (PRACH) reception, usage of eAxC for synchronization block (SSB) transmission, usage of eAxC for sounding reference signal (SRS) reception, antenna panel used for one of transmission or reception of the signal that is one of transmitted or received in the eAxC, antenna element used for reception or transmission of the signal that is one of transmitted or received in the eAxC, an LTE, IoT, 5G, or 6G technology of the signal one of transmitted or received in the eAxC, one of a time division (TDD) or frequency division (FDD) duplex type of the signal one of transmitted or received in the eAxC, optical port used for one of transmission or reception of the signal that is one of transmitted or received in the eAxC, or type of beamforming used for the signal that is one of transmitted or received in the eAxC.

A non-transitory computer-readable medium (MEM 10B as in FIG. 7) storing program code (PROG 10C as in FIG. 7), the program code executed by at least one processor (DP 10A as in FIG. 7) to perform the operations as at least described in the paragraphs above.

In accordance with an example embodiment of the invention as described above there is an apparatus comprising: means for identifying (one or more transceivers 10D; MEM 10B; PROG 10C; and DP 10A as in FIG. 7) by an Open Radio Access Radio unit (O-RU) (UE 10 as in FIG. 7) at least one extended Antenna-Carrier identifier (eAxC ID) profile for configuration (one or more transceivers 10D; MEM 10B; PROG 10C; and DP 10A as in FIG. 7) of at least one of cells or carriers by an operator of a communication network (Network 1 as in FIG. 7); means for using (one or more transceivers 10D; MEM 10B; PROG 10C; and DP 10A as in FIG. 7) an interface to send to an Open Radio Access Network distributed unit (O-DU) over an Open Radio Access Network (O-RAN) management plane (M-Plane) flow a capability report comprising a list of at least one extended Antenna-Carrier identifier (eAxC ID) subfield assignment supported by the Open Radio Access Network radio unit (O-RU), wherein based on the sending there is: mapping (one or more transceivers 10D; MEM 10B; PROG 10C; and DP 10A as in FIG. 7) of the supported at least one extended Antenna-Carrier identifier (eAxC ID) subfield assignment to the at least one extended Antenna-Carrier identifier (eAxC ID) profile; means for selection (one or more transceivers 10D, MEM 10B; PROG 10C; and DP 10A as in FIG. 7) of an optimal and mutually supported extended Antenna-Carrier identifier (eAxC ID) profile of the at least one extended Antenna-Carrier identifier (eAxC ID) profile. Then means, based on the selection, for configuration (one or more transceivers 10D; MEM 10B; PROG 10C; and DP 10A as in FIG. 7) of endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

In the example aspect of the invention according to the paragraph above, wherein at least the means for identifying, receiving, mapping, selecting, and configuring comprises a non-transitory computer readable medium [MEM 10B as in FIG. 7] encoded with a computer program [PROG 10C as in FIG. 7] executable by at least one processor [DP 10A as in FIG. 7].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this “circuitry” as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of circuitry′ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

### EMBODIMENTS

### Embodiment 1

An Open Radio Access Network distributed unit (O-DU), comprising:
at least one processor; and
at least one non-transitory memory including computer program code, where the at least one non-transitory memory and the computer program code are configured, with the at least one processor, to cause the Open Radio Access Network distributed unit to at least:
   identify at least one extended Antenna-Carrier identifier (eAxC ID) profile for configuration of at least one of cells or carriers by an operator of a communication network;
receive over an Open Radio Access Network (O-RAN) management plane (M-Plane) flow from an Open Radio Access Network radio unit (O-RU) a capability report comprising a list of at least one extended Antenna-Carrier identifier (eAxC ID) subfield assignment supported by the Open Radio Access Network radio unit (O-RU);
map the supported at least one extended Antenna-Carrier identifier (eAxC ID) subfield assignment to the at least one extended Antenna-Carrier identifier (eAxC ID) profile;
select an optimal and mutually supported extended Antenna-Carrier identifier (eAxC ID) profile of the at least one extended Antenna-Carrier identifier (eAxC ID) profile; and
based on the selecting, configure endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

### Embodiment 2

The apparatus of Embodiment 1, wherein configuring the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations.

### Embodiment 3

The apparatus of Embodiment 2, wherein the at least one of the Open Radio Access Network radio unit (O-RU) or Open Radio Access Network distributed unit (O-DU) processing operations are based on the O-RU or O-DU implementation being optimized for support of only selected eAxC ID subfield assignments or eAxC ID values.

### Embodiment 4

The apparatus of Embodiment 2, wherein configuring the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations.

### Embodiment 5

The apparatus of Embodiment 1, wherein the capability report is identifying supported assignment schemes of more than one subfield using the at least one of the Open Radio Access Network radio unit (O-RU) or Open Radio Access Network distributed unit (O-DU) processing operations.

### Embodiment 6

The apparatus of Embodiment 1, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU).

### Embodiment 7

The apparatus of Embodiment 1, wherein the at least one extended Antenna-Carrier identifier (eAxC ID) profile comprises extended Antenna-Carrier identifier (eAxC ID) assignments to leverage O-RU or O-DU processing.

### Embodiment 8

The apparatus of Embodiment 1, wherein the supported Antenna-Carrier identifier (eAxC ID) profile are implemented on the O-DU and the O-RU.

### Embodiment 9

The apparatus of Embodiment 1, wherein each of the at least one Antenna-Carrier identifier (eAxC ID) profile is uniquely identified by the Antenna-Carrier identifier (eAxC ID) subfield assignment.

### Embodiment 10

The apparatus of Embodiment 1, wherein the O-RU reports over O-RAN M-Plane the supported Antenna-Carrier identifier (eAxC ID) subfield assignments to inform the communication network about the supported eAxC profile.

### Embodiment 11

The apparatus of Embodiment 1, wherein each of the eAxC ID profiles is uniquely identified by the eAxC ID subfield assignment.

### Embodiment 12

The apparatus of Embodiment 1, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures.

### Embodiment 13

The apparatus of Embodiment 10, wherein after at least one of cell or carrier configuration, the O-DU activates cells or carriers and C/U-Plane data is exchanged and processed according to the O-RAN standard procedures.

### Embodiment 14

The apparatus of Embodiment 10, wherein the O-DU retrieves the list of the supported eAxC ID subfield assignments as described in the section, wherein the O-DU maps the eAxC ID subfield assignments supported by O-RU to the eAxC ID profiles, and wherein based on the at least one of cell or carrier configuration provided by the operator of the communication network, O-DU selects the optimal eAxC ID profile that is supported by both the O-RU and the O-DU.

### Embodiment 15

The apparatus of Embodiment 14, wherein the list comprises a list of tuples comprising a DU_Port_ID, BandSector_ID, CC_ID and RU_Port_ID.

### Embodiment 16

The apparatus of Embodiment 1, wherein examples of eAxC characteristics that can be used for selecting the optimal and mutually supported eAxC ID profile comprise at least one of:
polarization of the signal that is one of transmitted or received in the eAxC,
band of the one of transmitting or receiving the signal of the eAxC,
frequency range of the one of transmitted or received signal of the eAxC, or physical sector of the one of transmitted or received signal of the eAxC, and
wherein selecting the optimal and mutually supported eAxC ID profile comprises at least one of:
usage of eAxC for physical random access channel (PRACH) reception,
usage of eAxC for synchronization block (SSB) transmission,
usage of eAxC for sounding reference signal (SRS) reception,
antenna panel used for one of transmission or reception of the signal that is one of transmitted or received in the eAxC,
antenna element used for reception or transmission of the signal that is one of transmitted or received in the eAxC,
an LTE, IoT, 5G, or 6G technology of the signal one of transmitted or received in the eAxC,
one of a time division (TDD) or frequency division (FDD) duplex type of the signal one of transmitted or received in the eAxC,
optical port used for one of transmission or reception of the signal that is one of transmitted or received in the eAxC, or
type of beamforming used for the signal that is one of transmitted or received in the eAxC.

### Embodiment 17

A method, comprising:
identifying by an Open Radio Access Network distributed unit (O-DU) at least one extended Antenna-Carrier identifier (eAxC ID) profile for configuration of at least one of cells or carriers by an operator of a communication network;
receiving over an Open Radio Access Network (O-RAN) management plane (M-Plane) flow from an Open Radio Access Network radio unit (O-RU) a capability report comprising a list of at least one extended Antenna-Carrier identifier (eAxC ID) subfield assignment supported by the Open Radio Access Network radio unit (O-RU);
mapping the supported at least one extended Antenna-Carrier identifier (eAxC ID) subfield assignment to the at least one extended Antenna-Carrier identifier (eAxC ID) profile;
selecting an optimal and mutually supported extended Antenna-Carrier identifier (eAxC ID) profile of the at least one extended Antenna-Carrier identifier (eAxC ID) profile; and
based on the selecting, configuring endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

### Embodiment 18

The method of Embodiment 17, wherein configuring the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations.

### Embodiment 19

The method of Embodiment 18, wherein the at least one of the Open Radio Access Network radio unit (O-RU) or Open Radio Access Network distributed unit (O-DU) processing operations are based on the O-RU or O-DU implementation being optimized for support of only selected eAxC ID subfield assignments or eAxC ID values.

### Embodiment 20

The method of Embodiment 18, wherein configuring the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations.

### Embodiment 21

The method of Embodiment 17, wherein the capability report is identifying supported assignment schemes of more than one subfield using the at least one of the Open Radio Access Network radio unit (O-RU) or Open Radio Access Network distributed unit (O-DU) processing operations.

### Embodiment 22

The method of Embodiment 17, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU).

### Embodiment 23

The method of Embodiment 17, wherein the at least one extended Antenna-Carrier identifier (eAxC ID) profile comprises extended Antenna-Carrier identifier (eAxC ID) assignments to leverage O-RU or O-DU processing.

### Embodiment 24

The method of Embodiment 17, wherein the supported Antenna-Carrier identifier (eAxC ID) profile are implemented on the O-DU and the O-RU.

### Embodiment 25

The method of Embodiment 17, wherein each of the at least one Antenna-Carrier identifier (eAxC ID) profile is uniquely identified by the Antenna-Carrier identifier (eAxC ID) subfield assignment.

### Embodiment 26

The method of Embodiment 17, wherein the O-RU reports over O-RAN M-Plane the supported Antenna-Carrier identifier (eAxC ID) subfield assignments to inform the communication network about the supported eAxC profile.

### Embodiment 27

The method of Embodiment 17, wherein each of the eAxC ID profiles is uniquely identified by the eAxC ID subfield assignment.

### Embodiment 28

The method of Embodiment 17, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures.

### Embodiment 29

The method of Embodiment 26, wherein after at least one of cell or carrier configuration, the O-DU activates cells or carriers and C/U-Plane data is exchanged and processed according to the O-RAN standard procedures.

### Embodiment 30

The method of Embodiment 26, wherein the O-DU retrieves the list of the supported eAxC ID subfield assignments as described in the section, wherein the O-DU maps the eAxC ID subfield assignments supported by O-RU to the eAxC ID profiles, and wherein based on the at least one of cell or carrier configuration provided by the operator of the communication network, O-DU selects the optimal eAxC ID profile that is supported by both the O-RU and the O-DU.

### Embodiment 31

The method of Embodiment 30, wherein the list comprises a list of tuples comprising a DU_Port_ID, BandSector_ID, CC_ID and RU_Port_ID.

### Embodiment 32

The method of Embodiment 17, wherein examples of eAxC characteristics that can be used for selecting the optimal and mutually supported eAxC ID profile comprise at least one of:
polarization of the signal that is one of transmitted or received in the eAxC,
band of the one of transmitting or receiving the signal of the eAxC,
frequency range of the one of transmitted or received signal of the eAxC, or physical sector of the one of transmitted or received signal of the eAxC, and
wherein selecting the optimal and mutually supported eAxC ID profile comprises at least one of:
usage of eAxC for physical random access channel (PRACH) reception,
usage of eAxC for synchronization block (SSB) transmission,
usage of eAxC for sounding reference signal (SRS) reception,
antenna panel used for one of transmission or reception of the signal that is one of transmitted or received in the eAxC,
antenna element used for reception or transmission of the signal that is one of transmitted or received in the eAxC,
an LTE, IoT, 5G, or 6G technology of the signal one of transmitted or received in the eAxC,
one of a time division (TDD) or frequency division (FDD) duplex type of the signal one of transmitted or received in the eAxC,
optical port used for one of transmission or reception of the signal that is one of transmitted or received in the eAxC, or
type of beamforming used for the signal that is one of transmitted or received in the eAxC.

### Embodiment 33

An Open Radio Access Radio unit (O-RU), comprising:
at least one processor; and
at least one non-transitory memory including computer program code, where the at least one non-transitory memory and the computer program code are configured, with the at least one processor, to cause the Open Radio Access Network Radio unit to at least:
identify at least one extended Antenna-Carrier identifier (eAxC ID) profile for configuration of at least one of cells or carriers by an operator of a communication network;
use an interface to send to an Open Radio Access Network distributed unit (O-DU) over an Open Radio Access Network (O-RAN) management plane (M-Plane) flow a capability report comprising a list of at least one extended Antenna-Carrier identifier (eAxC ID) subfield assignment supported by the Open Radio Access Network radio unit (O-RU), wherein based on the sending there is:
mapping of the supported at least one extended Antenna-Carrier identifier (eAxC ID) subfield assignment to the at least one extended Antenna-Carrier identifier (eAxC ID) profile;
selection of an optimal and mutually supported extended Antenna-Carrier identifier (eAxC ID) profile of the at least one extended Antenna-Carrier identifier (eAxC ID) profile; and
based on the selection, configuration of endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

### Embodiment 34

The Open Radio Access Radio unit of Embodiment 33, wherein the configuration of the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations.

### Embodiment 35

The Open Radio Access Radio unit of Embodiment 34, wherein the at least one of the Open Radio Access Network radio unit (O-RU) or Open Radio Access Network distributed unit (O-DU) processing operations is based on the O-RU or O-DU implementation being optimized for support of only selected eAxC ID subfield assignments or eAxC ID values.

### Embodiment 36

The Open Radio Access Radio unit of Embodiment 34, wherein configuration of the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations.

### Embodiment 37

The Open Radio Access Radio unit of Embodiment 33, wherein the interface to send the list of the supported at least one extended Antenna-Carrier identifier (eAxC ID) subfield assignment comprises a a list of tuples comprising a DU_Port_ID, BandSector_ID, CC_ID and RU_Port ID.

### Embodiment 38

The Open Radio Access Radio unit of Embodiment 33, wherein the capability report is identifying supported assignment schemes of more than one subfield using the at least one of the Open Radio Access Network radio unit (O-RU) or Open Radio Access Network distributed unit (O-DU) processing operations.

### Embodiment 39

The Open Radio Access Radio unit of Embodiment 33, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU).

### Embodiment 40

The Open Radio Access Radio unit of Embodiment 33, wherein the at least one extended Antenna-Carrier identifier (eAxC ID) profile comprises extended Antenna-Carrier identifier (eAxC ID) assignments to leverage O-RU or O-DU processing.

### Embodiment 41

The Open Radio Access Radio unit of Embodiment 33, wherein the supported Antenna-Carrier identifier (eAxC ID) profile are implemented on the O-DU and the O-RU.

### Embodiment 42

The Open Radio Access Radio unit of Embodiment 33, wherein each of the at least one Antenna-Carrier identifier (eAxC ID) profile is uniquely identified by the Antenna-Carrier identifier (eAxC ID) subfield assignment.

### Embodiment 43

The Open Radio Access Radio unit of Embodiment 33, wherein the O-RU reports over O-RAN M-Plane the supported Antenna-Carrier identifier (eAxC ID) subfield assignments to inform the communication network about the supported eAxC profile.

### Embodiment 44

The Open Radio Access Radio unit of Embodiment 33, wherein each of the eAxC ID profiles is uniquely identified by the eAxC ID subfield assignment.

### Embodiment 45

The Open Radio Access Radio unit of Embodiment 33, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures.

### Embodiment 46

The Open Radio Access Radio unit of Embodiment 44, wherein after at least one of cell or carrier configuration, the O-DU activates cells or carriers and C/U-Plane data is exchanged and processed according to the O-RAN standard procedures.

### Embodiment 47

The Open Radio Access Radio unit of Embodiment 43, wherein the O-DU retrieves the list of the supported eAxC ID subfield assignments, wherein the O-DU maps the eAxC ID subfield assignments supported by O-RU to the eAxC ID profiles as described in the section, and wherein based on the at least one of cell or carrier configuration provided by the operator of the communication network, O-DU selects the optimal eAxC ID profile that is supported by both the O-RU and the O-DU.

### Embodiment 48

The Open Radio Access Radio unit of Embodiment 33, wherein examples of eAxC characteristics that can be used for selecting the optimal and mutually supported eAxC ID profile comprise at least one of:
polarization of the one of transmitted or received signal of the eAxC,
band of the one of transmitted or received signal of the eAxC,
frequency range of the one of transmitted or received signal of the eAxC, or
physical sector of the transmitted/received signal that is one of transmitted or received in the eAxC,
wherein selecting the optimal and mutually supported eAxC ID profile comprise at least one of:
usage of eAxC for physical random access channel (PRACH) reception,
usage of eAxC for synchronization block (SSB) transmission,
usage of eAxC for sounding reference signal (SRS) reception,
antenna panel used for one of transmission or reception of the signal that is one of transmitted or received in the eAxC,
antenna element used for reception or transmission of the signal that is one of transmitted or received in the eAxC,
an LTE, IoT, 5G, or 6G technology of the signal one of transmitted or received in the eAxC, one of a time division (TDD) or frequency division (FDD) duplex type of the signal one of transmitted or received in the eAxC,
optical port used for one of transmission or reception of the signal that is one of transmitted or received in the eAxC, or
type of beamforming used for the signal that is one of transmitted or received in the eAxC.

### Embodiment 49

A method comprising:
identifying by an Open Radio Access Radio unit (O-RU)at least one extended Antenna-Carrier identifier (eAxC ID) profile for configuration of at least one of cells or carriers by an operator of a communication network;
using an interface to send to an Open Radio Access Network distributed unit (O-DU) over an Open Radio Access Network (O-RAN) management plane (M-Plane) flow a capability report comprising a list of at least one extended Antenna-Carrier identifier (eAxC ID) subfield assignment supported by the Open Radio Access Network radio unit (O-RU), wherein based on the sending there is:
mapping of the supported at least one extended Antenna-Carrier identifier (eAxC ID) subfield assignment to the at least one extended Antenna-Carrier identifier (eAxC ID) profile;
selection of an optimal and mutually supported extended Antenna-Carrier identifier (eAxC ID) profile of the at least one extended Antenna-Carrier identifier (eAxC ID) profile; and
based on the selection, configuration of endpoints with extended Antenna-Carrier identifier (eAxC ID) subfield assignment and extended Antenna-Carrier identifier (eAxC ID) values for one of transmitting or receiving a signal for data exchange to available resources over control signal and user data exchange planes (C/U).

### Embodiment 50

The method of Embodiment 49, wherein the configuration of the endpoints with extended Antenna-Carrier identifier (eAxC ID) subfield assignment and extended Antenna-Carrier identifier (eAxC ID) values for the data exchange is using at least one of an Open Radio Access Network radio unit (O-RU) or Open Radio Access Network distributed unit (O-DU) processing operations.

### Embodiment 51

The method of Embodiment 50, wherein the at least one of the Open Radio Access Network radio unit (O-RU) or Open Radio Access Network distributed unit (O-DU) processing operations is based on the O-RU or O-DU implementation being optimized for support of only selected eAxC ID subfield assignments or eAxC ID values.

### Embodiment 52

The method of Embodiment 50, wherein configuration of the endpoints with extended Antenna-Carrier identifier (eAxC ID) subfield assignment and extended Antenna-Carrier identifier (eAxC ID) values is for a load balanced data exchange using the at least one of the Open Radio Access Network radio unit (O-RU) or Open Radio Access Network distributed unit (O-DU) processing operations.

### Embodiment 53

The method of Embodiment 49, wherein the interface to send the list of the supported at least one extended Antenna-Carrier identifier (eAxC ID) subfield assignment comprises a a list of tuples comprising a DU_Port_ID, BandSector_ID, CC_ID and RU Port ID.

### Embodiment 54

The method of Embodiment 49, wherein the capability report is identifying supported assignment schemes of more than one subfield using the at least one of the Open Radio Access Network radio unit (O-RU) or Open Radio Access Network distributed unit (O-DU) processing operations.

### Embodiment 55

The method of Embodiment 49, wherein the at least one extended Antenna-Carrier identifier (eAxC ID) profile describes extended Antenna-Carrier identifier (eAxC ID) processing capabilities of at least one of the Open Radio Access Network radio unit (O-RU) or the Open Radio Access Network distributed unit (O-DU).

### Embodiment 56

The method of Embodiment 49, wherein the at least one extended Antenna-Carrier identifier (eAxC ID) profile comprises extended Antenna-Carrier identifier (eAxC ID) assignments to leverage O-RU or O-DU processing.

### Embodiment 57

The method of Embodiment 49, wherein the supported Antenna-Carrier identifier (eAxC ID) profile are implemented on the O-DU and the O-RU.

### Embodiment 58

The method of Embodiment 49, wherein each of the at least one Antenna-Carrier identifier (eAxC ID) profile is uniquely identified by the Antenna-Carrier identifier (eAxC ID) subfield assignment.

### Embodiment 59

The method of Embodiment 49, wherein the O-RU reports over O-RAN M-Plane the supported Antenna-Carrier identifier (eAxC ID) subfield assignments to inform the communication network about the supported eAxC profile.

### Embodiment 60

The method of Embodiment 49, wherein each of the eAxC ID profiles is uniquely identified by the eAxC ID subfield assignment.

### Embodiment 61

The method of Embodiment 49, wherein as a part of at least one of cell or carrier configuration on the Open Radio Access Network radio unit (O-RU), the Open Radio Access Network distributed unit (O-DU) configures the endpoints on both O-DU and O-RU side with the selected eAxC ID subfield assignments and calculated eAxC ID values basing on the selected profile according to the standard procedures.

### Embodiment 62

The method of Embodiment 60, wherein after at least one of cell or carrier configuration, the O-DU activates cells or carriers and C/U-Plane data is exchanged and processed according to the O-RAN standard procedures.

### Embodiment 63

The method of Embodiment 59, wherein the O-DU retrieves the list of the supported eAxC ID subfield assignments, wherein the O-DU maps the eAxC ID subfield assignments supported by O-RU to the eAxC ID profiles as described in the section, and wherein based on the at least one of cell or carrier configuration provided by the operator of the communication network, O-DU selects the optimal eAxC ID profile that is supported by both the O-RU and the O-DU.

### Embodiment 64

The method of Embodiment 49, wherein examples of eAxC characteristics that can be used for selecting the optimal and mutually supported eAxC ID profile comprise at least one of:
polarization of the one of transmitted or received signal of the eAxC,
band of the one of transmitted or received signal of the eAxC,
frequency range of the one of transmitted or received signal of the eAxC, or
physical sector of the transmitted/received signal that is one of transmitted or received in the eAxC,
wherein selecting the optimal and mutually supported eAxC ID profile comprise at least one of:
usage of eAxC for physical random access channel (PRACH) reception,
usage of eAxC for synchronization block (SSB) transmission,
usage of eAxC for sounding reference signal (SRS) reception,
antenna panel used for one of transmission or reception of the signal that is one of transmitted or received in the eAxC,
antenna element used for reception or transmission of the signal that is one of transmitted or received in the eAxC,
an LTE, IoT, 5G, or 6G technology of the signal one of transmitted or received in the eAxC,
one of a time division (TDD) or frequency division (FDD) duplex type of the signal one of transmitted or received in the eAxC,
optical port used for one of transmission or reception of the signal that is one of transmitted or received in the eAxC, or
type of beamforming used for the signal that is one of transmitted or received in the eAxC.

1. An open radio access network distributed unit, comprising:
at least one processor; and
at least one memory storing instructions that, when executed with the at least one processor, cause the open radio access network distributed unit to at least:
identify at least one extended antenna-carrier identifier profile for configuration of at least one of cells or carriers with an operator of a communication network;
receive over an open radio access network management plane flow from an open radio access network radio unit a capability report comprising a list of at least one extended antenna-carrier identifier subfield assignment supported with the open radio access network radio unit;
map the supported at least one extended antenna-carrier identifier subfield assignment to the at least one extended antenna-carrier identifier profile;
select an optimal and mutually supported extended antenna-carrier identifier profile of the at least one extended antenna-carrier identifier profile; and
based on the selecting, configure endpoints with extended antenna-carrier identifier subfield assignment and extended antenna-carrier identifier values for one of transmitting or receiving a signal for data exchange to available resources over control signal and user data exchange planes.

2. The open radio access network distributed unit of claim 1, wherein the instructions, when executed with the at least one processor, cause the open radio access network distributed unit to configure the endpoints with extended antenna-carrier identifier subfield assignment and extended antenna-carrier identifier values for the data exchange using at least one of an open radio access network radio unit or open radio access network distributed unit processing operations.

3. The open radio access network distributed unit of claim 2, wherein the at least one of the open radio access network radio unit or open radio access network distributed unit processing operations are based on the open radio access network radio unit or open radio access network distributed unit implementation being optimized for support of selected extended antenna-carrier identifier subfield assignments or extended antenna-carrier identifier values.

4. (canceled)

5. The open radio access network distributed unit of claim 1, wherein the instructions, when executed with the at least one processor, cause the open radio access network distributed unit to cause the capability report to identify supported assignment schemes of more than one subfield using the at least one of the open radio access network radio unit or open radio access network distributed unit processing operations.

6. The open radio access network distributed unit of claim 1, wherein the at least one extended antenna-carrier identifier profile describes extended antenna-carrier identifier processing capabilities of at least one of the open radio access network radio unit or the open radio access network distributed unit.

7. The open radio access network distributed unit of claim 1, wherein the at least one extended antenna-carrier identifier profile comprises extended antenna-carrier identifier assignments to leverage open radio access network radio unit or open radio access network distributed unit processing.

8-9. (canceled)

10. The open radio access network distributed unit of claim 1, wherein the instructions, when executed with the at least one processor, cause the open radio access network distributed unit to cause the open radio access network radio unit to report over open radio access network management plane the supported antenna-carrier identifier subfield assignments to inform the communication network about the supported extended antenna-carrier identifier profile.

11-16. (canceled)

17. A method, comprising:
identifying with an open radio access network distributed unit at least one extended antenna-carrier identifier profile for configuration of at least one of cells or carriers with an operator of a communication network;
receiving over an open radio access network management plane flow from an open radio access network radio unit a capability report comprising a list of at least one extended antenna-carrier identifier subfield assignment supported with the open radio access network radio unit;
mapping the supported at least one extended antenna-carrier identifier subfield assignment to the at least one extended antenna-carrier identifier profile;
selecting an optimal and mutually supported extended antenna-carrier identifier profile of the at least one extended antenna-carrier identifier profile; and
based on the selecting, configuring endpoints with extended antenna-carrier identifier subfield assignment and extended antenna-carrier identifier values for one of transmitting or receiving a signal for data exchange to available resources over control signal and user data exchange planes.

18. The method of claim 17, wherein configuring the endpoints with extended antenna-carrier identifier subfield assignment and extended antenna-carrier identifier values for the data exchange is using at least one of an open radio access network radio unit or open radio access network distributed unit processing operations.

19. The method of claim 18, wherein the at least one of the open radio access network radio unit or open radio access network distributed unit processing operations are based on the open radio access network radio unit or open radio access network distributed unit implementation being optimized for support of selected extended antenna-carrier identifier subfield assignments or extended antenna-carrier identifier values.

20. (canceled)

21. The method of claim 17, wherein the capability report is identifying supported assignment schemes of more than one subfield using the at least one of the open radio access network radio unit open radio access network distributed unit processing operations.

22. The method of claim 17, wherein the at least one extended antenna-carrier identifier profile describes extended antenna-carrier identifier processing capabilities of at least one of the open radio access network radio unit or the open radio access network distributed unit.

23. The method of claim 17, wherein the at least one extended antenna-carrier identifier profile comprises extended antenna-carrier identifier assignments to leverage open radio access network radio unit or open radio access network distributed unit processing.

24-25. (canceled)

26. The method of claim 17, wherein the open radio access network radio unit reports over open radio access network management plane the supported antenna-carrier identifier subfield assignments to inform the communication network about the supported extended antenna-carrier identifier profile.

27-32. (canceled)

33. An open radio access radio unit, comprising:
at least one processor; and
at least one memory storing instructions that, when executed with the at least one processor, cause the open radio access network radio unit to at least:
identify at least one extended antenna-carrier identifier profile for configuration of at least one of cells or carriers with an operator of a communication network;
use an interface to send to an open radio access network distributed unit over an open radio access network management plane flow a capability report comprising a list of at least one extended antenna-carrier identifier subfield assignment supported with the open radio access network radio unit wherein based on the sending there is:
mapping of the supported at least one extended antenna-carrier identifier subfield assignment to the at least one extended antenna-carrier identifier profile;
selection of an optimal and mutually supported extended antenna-carrier identifier profile of the at least one extended antenna-carrier identifier profile; and
based on the selection, configuration of endpoints with extended antenna-carrier identifier subfield assignment and extended antenna-carrier identifier values for one of transmitting or receiving a signal for data exchange to available resources over control signal and user data exchange planes.

34. The open radio access radio unit of claim 33, wherein the instructions, when executed with the at least one processor, cause the open radio access radio unit to configure the endpoints with extended antenna-carrier identifier subfield assignment and extended antenna-carrier identifier values for the data exchange using at least one of an open radio access network radio unit or open radio access network distributed unit processing operations.

35. The open radio access radio unit of claim 34, wherein the at least one of the open radio access network radio unit or open radio access network distributed unit processing operations is based on the open radio access network radio unit or open radio access network distributed unit implementation being optimized for support of selected extended antenna-carrier identifier subfield assignments or extended antenna-carrier identifier values.

36. (canceled)

37. The open radio access radio unit of claim 33, wherein the interface to send the list of the supported at least one extended antenna-carrier identifier subfield assignment comprises a list of tuples comprising a DU_Port_ID, BandSector_ID, CC_ID and RU_Port_ID.

38. The open radio access radio unit of claim 33, wherein the instructions, when executed with the at least one processor, cause the open radio access radio unit to cause the capability report to identify supported assignment schemes of more than one subfield using the at least one of the open radio access network radio unit open radio access network distributed unit processing operations.

39. (canceled)

40. The open radio access radio unit of claim 33, wherein the at least one extended antenna-carrier identifier profile comprises extended antenna-carrier identifier assignments to leverage open radio access network radio unit or open radio access network distributed unit processing.

41-64. (canceled)
